(19) United States
(12) Patent Application Publication
(10) Pub. No.: US 2025/0105399 A1
(43) Pub. Date: Mar. 27, 2025

(54) PRISMATIC BATTERY CELL

(71) Applicant: GM Global Technology Operations LLC, Detroit, MI (US)

(72) Inventors: Youngmin Chung, Troy, MI (US); Su Jung Han, West Bloomfield, MI (US); Vincent Edward Herrman, Clawson, MI (US)

(21) Appl. No.: 18/472,319

(22) Filed: Sep. 22, 2023

(51) Int. Cl. H01M 10/658; H01M 10/0585; H01M 10/647; H01M 50/103; H01M 50/534

(52) U.S. Cl. CPC H01M 10/658; H01M 10/0585; H01M 10/647; H01M 50/103; H01M 50/534

(57) ABSTRACT

A prismatic battery having a first electrode stack, second electrode stack and a thermal barrier disposed between the first and second electrode stack. The first electrode stack has a first anode, a first cathode and a first separator disposed between the first anode and the first cathode. The second electrode stack has a second anode, a second cathode and a second separator disposed between the second anode and the second cathode. The first electrode stack, the thermal barrier and the second electrode stack form a first cell or stack assembly. The first stack assembly is disposed within an interior of a housing containing an electrolyte.

### INTRODUCTION

The present disclosure relates to a prismatic battery cell and more particularly to a prismatic battery cell that has thermal management.

A rechargeable energy storage system (RESS), for example a prismatic battery, includes typically a plurality of electrode stacks. Each of the electrode stacks includes an anode and a cathode spaced apart by an electrically insulative separator material. The electrode stacks are placed next to one another typically in a case or enclosure to protect the electrode stacks from the ambient environment. The case also functions to contain an electrolyte fluid within the case and around the electrode stacks. An electrode stack in an RESS may undergo an uncontrolled thermal event known as thermal runaway propagation (TRP). During a TRP event the electrode undergoing uncontrolled thermal runaway, called the triggering electrode, may cause a neighboring electrode stack to also undergo an increase in temperature. Increasing the temperature over one or more electrode stacks may cause the entire RESS to increase in temperature and pressure. The increase in pressure and temperature in the RESS due to gas production may lead to the seal on the case of the RESS to leak.

While prior art methods and systems for managing or controlling TRP events exist and may achieve their particular purposes a need still exists for a new and improved RESS. Accordingly, prismatic battery cell assemblies that have multiple electrode stacks that are configured to control a TRP event is needed.

### SUMMARY

According to several aspects of the present disclosure, a prismatic battery is provided. The prismatic battery has a first electrode stack having a first anode, a first cathode and a first separator disposed between the first anode and the first cathode, a second electrode stack having a second anode, a second cathode and a second separator disposed between the second anode and the second cathode, a thermal barrier disposed between the first and second electrode stack. The first electrode stack, the thermal barrier and the second electrode stack form a first stack assembly. The prismatic battery further includes a housing containing an electrolyte. The first stack assembly is disposed within an interior of the housing and submerged in the electrolyte.

In accordance with another aspect of the disclosure the prismatic battery further includes a thermally insulative tape wrapped around the first stack assembly wherein the insulative tape has a first and second surface wherein one of the first and second surfaces has an adhesive disposed thereon for adhering the thermally insulative tape to the first stack assembly.

In accordance with another aspect of the disclosure the prismatic battery further includes a first thermal insulative sheet disposed on a first side of the first stack assembly.

In accordance with another aspect of the disclosure the prismatic battery further includes a thermally insulative tape wrapped around the first thermal insulative sheet disposed on the first side of the first stack assembly wherein the insulative tape has a first and second surface wherein one of the first and second surfaces has an adhesive disposed thereon for adhering the insulative tape to the first stack assembly thereby securing the first thermal insulative sheet to the first stack assembly.

In accordance with another aspect of the disclosure the prismatic battery further includes a second thermal insulative sheet disposed on a second side of the first stack assembly.

In accordance with another aspect of the disclosure the prismatic battery further includes a thermally insulative tape wrapped around the first thermal insulative sheet disposed on the first side of the first stack assembly and the second thermal insulative sheet disposed on the second side of the first stack assembly wherein the insulative tape has a first and second surface wherein one of the first and second surfaces has an adhesive disposed thereon for adhering the insulative tape to the first stack assembly thereby securing the first and second thermal insulative sheet to the first stack assembly.

In accordance with another aspect of the disclosure the prismatic battery further includes a third thermal insulative sheet disposed on a third side of the first stack assembly.

In accordance with another aspect of the disclosure the prismatic battery further includes a thermally insulative tape wrapped around the first thermal insulative sheet disposed on the first side of the first stack assembly, the second thermal insulative sheet disposed on the second side of the first stack assembly and the third thermal insulative sheet disposed on the third side of the first stack assembly wherein the insulative tape has a first and second surface wherein one of the first and second surfaces has an adhesive disposed thereon for adhering the insulative tape to the first stack assembly thereby securing the first, second and third thermal insulative sheet to the first stack assembly.

In accordance with another aspect of the disclosure the prismatic battery further includes a fourth thermal insulative sheet disposed on a fourth side of the first stack assembly.

In accordance with another aspect of the disclosure the prismatic battery further includes a thermally insulative tape wrapped around the first thermal insulative sheet disposed on the first side of the first stack assembly, the second thermal insulative sheet disposed on the second side of the first stack assembly and the third thermal insulative sheet disposed on the third side of the first stack assembly and the fourth thermal insulative sheet disposed on the fourth side of the first stack assembly wherein the insulative tape has a first and second surface wherein one of the first and second surfaces has an adhesive disposed thereon for adhering the insulative tape to the first stack assembly thereby securing the first, second, third and fourth thermal insulative sheet to the first stack assembly.

In accordance with another aspect of the disclosure the prismatic battery further includes a first tab protruding from the first anode and a second tab protruding from the second anode wherein the first and second tab are made of copper and a third tab protruding from the first cathode and a fourth tab protruding from the second cathode wherein the third and fourth tab are made of aluminum.

In accordance with yet another aspect of the disclosure a prismatic battery includes a first electrode stack having a first anode, a first cathode and a first separator disposed between the first anode and the first cathode, a second electrode stack having a second anode, a second cathode and a second separator disposed between the second anode and the second cathode, a thermal barrier disposed between the first and second electrode stack. The first electrode stack, the thermal barrier and the second electrode stack form a first stack assembly. The prismatic battery further includes a first thermal insulative sheet disposed on a first side of the first stack assembly and a housing containing an electrolyte. The first stack assembly is disposed within an interior of the housing and submerged in the electrolyte.

In accordance with another aspect of the disclosure the prismatic battery further includes a thermally insulative tape wrapped around the first stack assembly and the first thermal insulative sheet wherein the insulative tape has a first and second surface wherein one of the first and second surfaces has an adhesive disposed thereon for adhering the insulative tape to the first stack assembly and securing the first thermal insulative sheet to the first stack assembly.

In accordance with another aspect of the disclosure the prismatic battery further includes a second thermal insulative sheet disposed on a second side of the first stack assembly.

In accordance with another aspect of the disclosure the prismatic battery further includes a thermally insulative tape wrapped around the first thermal insulative sheet disposed on the first side of the first stack assembly and the second thermal insulative sheet disposed on the second side of the first stack assembly wherein the insulative tape has a first and second surface wherein one of the first and second surfaces has an adhesive disposed thereon for adhering the insulative tape to the first stack assembly thereby securing the first and second thermal insulative sheet to the first stack assembly.

In accordance with another aspect of the disclosure the prismatic battery further includes a third thermal insulative sheet disposed on a third side of the first stack assembly.

In accordance with another aspect of the disclosure the prismatic battery further includes a thermally insulative tape wrapped around the first thermal insulative sheet disposed on the first side of the first stack assembly, the second thermal insulative sheet disposed on the second side of the first stack assembly and the third thermal insulative sheet disposed on the third side of the first stack assembly wherein the insulative tape has a first and second surface wherein one of the first and second surfaces has an adhesive disposed thereon for adhering the insulative tape to the first stack assembly thereby securing the first, second and third thermal insulative sheet to the first stack assembly.

In accordance with another aspect of the disclosure the prismatic battery further includes a fourth thermal insulative sheet disposed on a fourth side of the first stack assembly.

In accordance with another aspect of the disclosure the prismatic battery further includes a thermally insulative tape wrapped around the first thermal insulative sheet disposed on the first side of the first stack assembly, the second thermal insulative sheet disposed on the second side of the first stack assembly, the third thermal insulative sheet disposed on the third side of the first stack assembly and the fourth thermal insulative sheet disposed on the fourth side of the first stack assembly wherein the insulative tape has a first and second surface wherein one of the first and second surfaces has an adhesive disposed thereon for adhering the insulative tape to the first stack assembly thereby securing the first, second, third and fourth thermal insulative sheet to the first stack assembly.

In accordance with still another aspect of the disclosure a prismatic battery further includes a first electrode stack having a first anode, a first cathode and a first separator disposed between the first anode and the first cathode, a second electrode stack having a second anode, a second cathode and a second separator disposed between the second anode and the second cathode, a thermal barrier disposed between the first and second electrode stack, wherein the first electrode stack, the thermal barrier and the second electrode stack form a first stack assembly, a first thermal insulative sheet disposed on a first side of the first stack assembly, a second thermal insulative sheet disposed on a second side of the first stack assembly, a third thermal insulative sheet disposed on a third side of the first stack assembly, a fourth thermal insulative sheet disposed on a fourth side of the first stack assembly, a thermally insulative tape wrapped around the first thermal insulative sheet disposed on the first side of the first stack assembly, the second thermal insulative sheet disposed on the second side of the first stack assembly, the third thermal insulative sheet disposed on the third side of the first stack assembly and the fourth thermal insulative sheet disposed on the fourth side of the first stack assembly. The insulative tape has a first and second surface wherein one of the first and second surfaces has an adhesive disposed thereon for adhering the insulative tape to the first stack assembly thereby securing the first, second and third thermal insulative sheet to the first stack assembly. The prismatic battery further includes a housing containing an electrolyte. The first stack assembly is disposed within an interior of the housing and submerged in the electrolyte.

### BRIEF DESCRIPTION OF THE DRAWINGS

The drawings described herein are for illustration purposes only and are not intended to limit the scope of the present disclosure in any way.

FIGS. 1A and 1B are perspective views of a prismatic battery cell assembly, illustrated in accordance with the present disclosure;

FIG. 2 is a perspective view of an alternate cell assembly having a first electrode stack and a second electrode stack separated by thermal barrier, illustrated in accordance with the present disclosure;

FIG. 3 is a perspective view of another alternate cell assembly having an insulative sheet positioned on top of and covering the electrode stacks and thermal barrier, illustrated in accordance with the present disclosure;

FIG. 4 is a perspective view of yet another alternate cell assembly having a first insulative sheet positioned on top of and covering the electrode stacks and thermal barrier and a second insulative sheet positioned below and covering the bottom of electrode stacks and thermal barrier, in accordance with the present disclosure;

FIG. 5 is a perspective view of still another alternate cell assembly having a first electrode stack and a second electrode stack separated by thermal barrier and further including a first insulative sheet, a second insulative sheet, a third insulative sheet, and a fourth insulative sheet surrounding the electrode stacks and thermal barrier, in accordance with the present disclosure; and

FIG. 6 is a chart illustrating the effect on temperature of an electrode stack assembled with neighboring electrode stacks in assemblies constructed as described in the present disclosure as compared to electrode stacks that are assembled with neighboring electrode stacks in assemblies that are not constructed as described in the present disclosure.

### DETAILED DESCRIPTION

The following description is merely exemplary in nature and is not intended to limit the present disclosure, application, or uses.

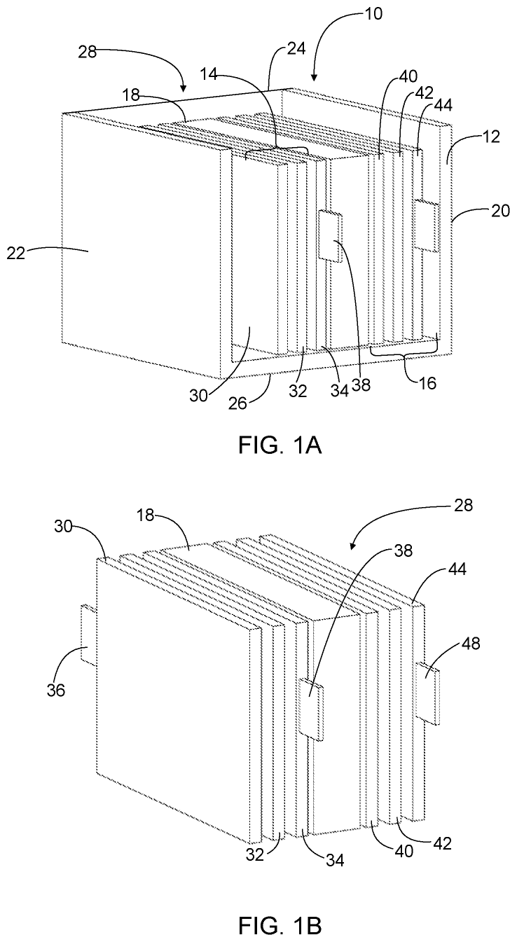

Referring now to FIGS. 1A and 1B, perspective views of a prismatic battery 10 having a housing or case 12, electrode stacks 14, 16 and a thermal barrier 18 are illustrated, in accordance with the present disclosure. The housing or case 12 is shown schematically in FIG. 1A and has a first side wall 20, a second side wall 22, third side wall 24, a bottom side wall 26, a top side wall (not shown) and a front side wall (not shown). The present disclosure contemplates other housing configurations for housing or case 12 and is not limited to the exemplary housing shown in FIG. 1A. Additionally, housing 12 contains a suitable electrolyte. For example, the electrolyte is a liquid solution of organic solvents and lithium salts. Electrode stacks 14 and 16 are submerged in the electrolyte contained in housing 12.

With continuing reference to FIGS. 1A and 1B a perspective view of electrode stacks 14 and 16 and thermal barrier 18 that form a cell or stack assembly 28 are illustrated, in accordance with the present disclosure. Electrode stack 14 is comprised of a negative electrode or anode electrode 30, a separator 32, and positive electrode or cathode electrode 34. Anode electrode 30 is generally a thin metal plate that includes an electrode tab 36 for providing an electrical connection between the anode electrode 30 and a terminal (not shown) on the exterior of the housing. Similarly, cathode electrode 34 is a thin metal plate that includes an electrode tab 38 for providing an electrical connection between the cathode electrode 34 and another terminal (not shown) on the exterior of the housing. Electrode tabs 36, 38 serve as current collectors. The voltage produced across the anode electrode 30 and cathode electrode 34 is communicated through the terminals on housing 12 to an external device (not shown). The anode electrode 30 and electrode tab 36 are made, for example, of copper or other suitable material and typically coated with graphite or graphite/silicon or other carbon-based materials or silicon oxide or lithiated silicon. The cathode electrode 34 and electrode tab 38 are made, for example, of aluminum or other suitable material and typically coated with a metal oxide, such as Lithium cobalt oxide (LCO) or nickel-cobalt-aluminum (NCA) or lithium iron/manganese phosphate (LFP/LFMP) or Lithium manganese rich (LMR).

The different metals (copper anode 30 and aluminum cathode 34) of prismatic battery 10 produce a galvanic reaction in battery 10. The copper, for example, of anode electrode 30 and the aluminum, for example, of cathode electrode 34 have different standard reduction potentials and are connected to an external circuit and separated by one another by the separator 32. The aluminum having the lower potential will oxidize and release electrons, while the copper having a higher potential will reduce and accept electrons. This process of releasing and accepting electrons generates an electric current that may be used to power devices.

Separator 32 is generally a thin a porous membrane or layer of material that is positioned between the anode electrode 30 and the cathode electrode 34 and prevents the anode and cathode from touching and causing a short circuit. Separator 32 allows the lithium ions to pass through and complete the circuit. A composite material that is porous and chemically stable such as composites made with polyethylene (PE), polypropylene (PP) or other natural materials of the like may be used as a separator 32. Moreover, inorganic nanoparticles such as TiO₂, SiO₂, Al₂O₃ and ZrO₂ may also be used to create coating composites for separator 32. Separator 32 increases the internal resistance of prismatic battery 10 that reduces power output and efficiency of the battery. The internal resistance depends on the thickness porosity and composition of separator 32. Preferably, a thinner, more porous and more conductive separator can lower the resistance and improve performance of the battery 10. Separator 32 is also selected to withstand high temperatures and manage thermal runaway preventing an uncontrollable rise in temperature due to exothermic reactions. Moreover, the separator 32 has a high melting point and a low shrinkage rate to avoid contact between the anode and cathode electrodes 30, 34. The separator 32 has sufficient mechanical strength to resist puncture, tear, or deformation during fabrication and operation of cell assembly 28. The separator 32 also is dimensionally stabile and flexible to conform to the shape of the electrodes 30, 34 and accommodate volume changes during cycling. The separator 32 is chemically inert and compatible with the electrolyte, electrodes 30, 34 and other cell components. Additionally, separator 32 has a low affinity for water or other impurities that can contaminate the electrolyte or cause corrosion of the electrodes 30, 34.

Like electrode stack 14, electrode stack 16 is comprised of an anode electrode 40, a separator 42, and a cathode electrode 44. While only one anode electrode 40 and one cathode electrode 44 separated by separator 42 are shown in the Figures, the present disclosure contemplates that the arrangement of anode electrode 40 and cathode electrode 44 separated by separator 42 may be repeated many times (i.e. ten to a hundred or more times) in each electrode stack 14, 16. Anode electrode 40 includes an electrode tab (not shown) for providing an electrical connection to the anode electrode 40. Similarly, cathode electrode 44 includes an electrode tab 48 for providing an electrical connection to the cathode electrode 44. Electrode stack 16 also includes a separator 42 disposed between the anode electrode 40 and a cathode electrode 44. Separator 42 is of the same make and composition as described above with respect to separator 32.

With continuing reference to FIG. 1B, the thermal barrier 18 is disposed or positioned between electrode stack 14 and electrode stack 16. Thermal barrier 18 is a thermally insulating material configured to prevent thermal heat transfer from one stack to the other. For example, thermal barrier 18 is a synthetic porous ultralight material derived from a gel in which the liquid component of the gel has been replaced with a gas. The resulting material, known as aerogel, is a solid with extremely low density and extremely low thermal conductivity. Aerogel of thermal barrier 18 may be made of a variety of chemical compounds such as, for example, a polymer-based aerogel that have an appearance and feel of rigid foams. The aerogel material can range from 50% to 99.98% air by volume. Aerogel of thermal barrier 18 has a porous solid network that contains air pockets where the air pockets take up the majority of the space within the thermal barrier 18. The aerogel of thermal barrier 18 prevents both conduction and convention modes of heat transfer. Additionally, to prevent the electrolyte solution infiltration of the thermal barrier 18, thermal barrier 18 is wrapped in a suitable non-ionic permeable barrier such as a polymer with laminated aluminum. Alternatively, thermal barrier 18 may be encapsulated or over molded in aluminum laminated plastic (i.e. PET film) to prevent the electrolyte solution from penetrating the thermal barrier 18. While only one thermal barrier 18 with an electrode stack 14, 16 on either side of the thermal barrier 18 is shown, the present disclosure contemplates a plurality of thermal barriers 18 disposed between a plurality of electrode stacks 14, 16 all contained in a housing 12 to form prismatic battery 10.

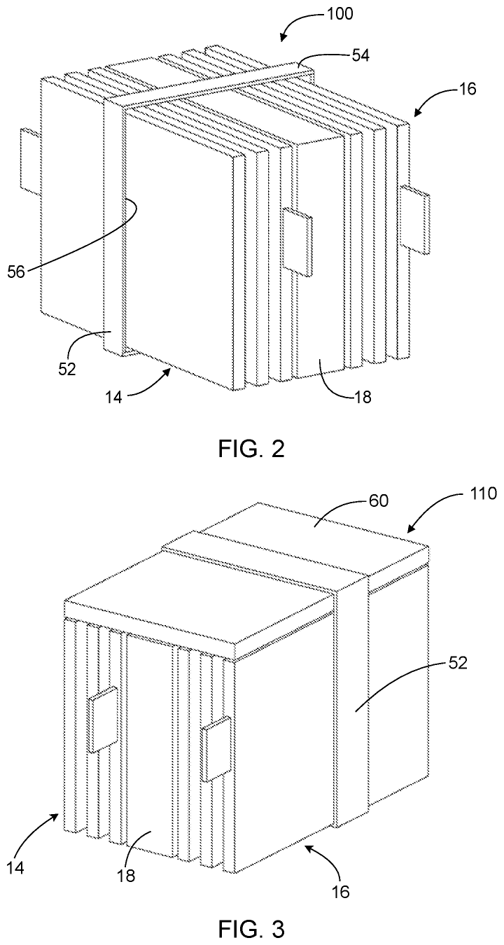

Referring now to FIG. 2, a perspective view of an alternate cell or stack assembly 100 having the electrode stack 14 and the electrode stack 16 separated by the thermal barrier 18 is illustrated, in accordance with the present invention. The electrode stacks 14, 16 and thermal barrier 18 have the same components described above where like components are referenced using the like reference numerals. Cell assembly 100 further includes an insulative tape 52 wrapped around the exterior of the electrode stacks 14, 16 and the thermal barrier 18. The insulative tape 52 has a first side 54 and a second side 56. The second side 56 is coated with a suitable adhesive and faces the exterior surfaces of the electrode stacks 14, 16 and thermal barrier 18. The insulative tape 52 with the adhesive coating functions to hold the cell assembly 100 together to form a single unit or assembly. Moreover, the insulative tape 52 is made of a material that inhibits heat transfer or heat conduction from the electrode stacks 14, 16 to components outside of electrode stacks 14, 16. The insulative tape 52 is made from Mica or other suitable non-heat conducting material. For example, a suitable Mica tape may include an inorganic high dielectric tape manufactured with mica paper and laminated to reinforcing substrates such as woven and non-woven glass cloths, non-woven polyester web, and/or polyester films including polyimide. Mica tape offered for sale by Goode EIS of Wujiang District, Suzhou City, Jiangsu Province is an example of a suitable insulative tape 52. While insulative tape 52 is shown in FIG. 2 as a single loop or wrap of tape around electrode stacks 14, 16 and the thermal barrier 18 the present disclosure contemplates multiple loops or wrappings of tape around electrode stacks 14, 16 and the thermal barrier 18.

Referring now to FIG. 3, a perspective view of another alternate cell or stack assembly 110 having an insulative sheet 60 positioned on top of and covering the electrode stacks 14, 16 and thermal barrier 18, in accordance with the present disclosure. The electrode stacks 14, 16 and thermal barrier 18 have the same components described above where like components are referenced using the like reference numerals. Insulative sheet 60 is sized to cover the entire top surfaces of the electrode stacks 14, 16 and the thermal barrier 18. Insulative sheet 60, for example may consist of 80-90% high grade Muscovite or alternatively Phlogopite mica paper impregnated with a high temperature resistant silicone resin or other similar composition. Moreover, insulative sheet 60 is configured to have thermal properties to inhibit heat transfer or heat conduction from the electrode stacks 14, 16. Cell assembly 110 is constructed by first placing or positioning the electrode stacks 14, 16 on either side of the thermal barrier 18 and then covering entirely or substantially the entire top surfaces of the electrode stacks 14, 16 and thermal barrier 18 with insulative sheet 60, and then wrapping insulative tape 52 around the exterior of the electrode stacks 14, 16, the thermal barrier 18 and the insulative sheet 60. Insulative tape 52 is as described above where like components or features are referenced using the like reference numerals. Insulative tape 52 with the adhesive coating functions to hold the cell assembly 110 together to form a single unit or assembly 110. While insulative tape 52 is shown in FIG. 3 as a single loop or wrap of tape around electrode stacks 14, 16, the thermal barrier 18 and insulative sheet 60, the present disclosure contemplates multiple loops or wrappings of tape around electrode stacks 14, 16, the thermal barrier 18 and insulative sheet 60.

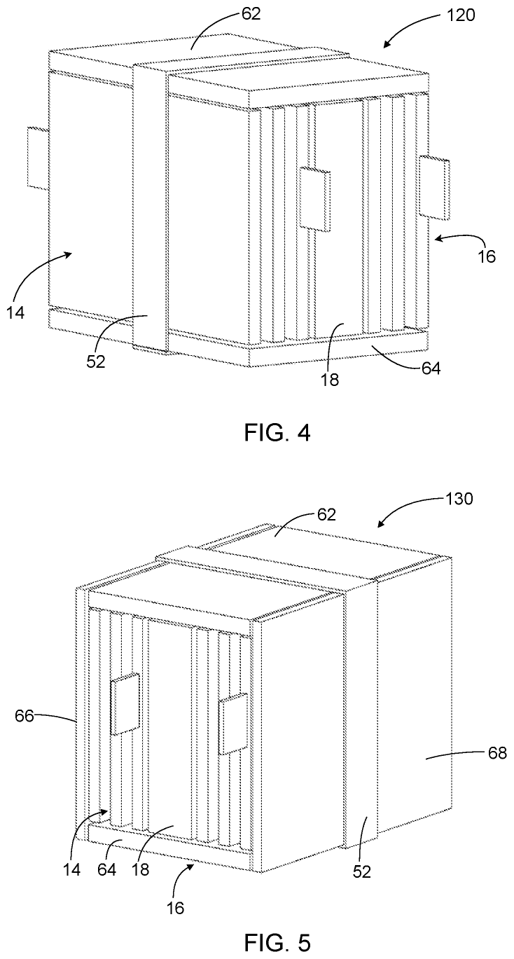

Referring now to FIG. 4, a perspective view of yet another alternate cell or stack assembly 120 having a first insulative sheet 62 positioned on top of and covering the electrode stacks 14, 16 and thermal barrier 18 and a second insulative sheet 64 positioned below and covering the bottom of electrode stacks 14, 16 and thermal barrier 18, in accordance with the present disclosure. The electrode stacks 14, 16 and thermal barrier 18 have the same components described above where like components are referenced using the like reference numerals. As stated above, cell assembly 120 further includes a first insulative sheet 62 disposed on top of the electrode stacks 14, 16 and the thermal barrier 18 and a second insulative sheet 64 disposed below the electrode stacks 14, 16 and the thermal barrier 18. First insulative sheet 62 is sized to cover the entire top surfaces of the electrode stacks 14, 16 and the thermal barrier 18 and second insulative sheet 64 is sized to cover the entire bottom surfaces of the electrode stacks 14, 16 and thermal barrier 18. First and second insulative sheets 62 and 64 have the same composition and make up as described above with respect to insulative sheet 60. Moreover, first and second insulative sheets 62, 64 are configured to have thermal properties to inhibit heat transfer or heat conduction from the electrode stacks 14, 16. Cell assembly 120 is constructed by first placing or positioning the electrode stacks 14, 16 on either side of the thermal barrier 18, covering entirely or substantially the entire top surfaces of the electrode stacks 14, 16 and thermal barrier 18 with first insulative sheet 62, covering the entire or substantially the entire bottom surfaces of the electrode stacks 14, 16 and thermal barrier 18 with insulative sheet 64 and then wrapping insulative tape 52 around the exterior of the electrode stacks 14, 16, the thermal barrier 18 and the insulative sheets 62, 64. Insulative tape 52 is configured as described above where like components or features are referenced using the like reference numerals. Insulative tape 52 with the adhesive coating functions to hold the cell assembly 120 together to form a single unit or assembly 120. While insulative tape 52 is shown in FIG. 4 as a single loop or wrap of tape around electrode stacks 14, 16, the thermal barrier 18 and first and second insulative sheets 62, 64, the present disclosure contemplates multiple loops or wrappings of tape around electrode stacks 14, 16, the thermal barrier 18 and first and second insulative sheets 62, 64.

Referring now to FIG. 5, a perspective view of still another alternate cell or stack assembly 130 having electrode stack 14 and the electrode stack 16 separated by thermal barrier 18 and further including a first insulative sheet 62, a second insulative sheet 64, a third insulative sheet 66, and a fourth insulative sheet 68, in accordance with the present disclosure. The electrode stacks 14, 16 and thermal barrier 18 have the same components described above where like components are referenced using the like reference numerals. First insulative sheet 62 is disposed on top of the electrode stacks 14, 16 and the thermal barrier 18, second insulative sheet 64 is disposed below the electrode stacks 14, 16 and the thermal barrier 18, third insulative sheet 66 is disposed adjacent the side surface of electrode stack 14 and fourth insulative sheet 68 is disposed adjacent the side surface of electrode stack 16. First insulative sheet 62 is sized to cover the entire or substantially the entire top surfaces of the electrode stacks 14, 16 and thermal barrier 18, second insulative sheet 64 is sized to cover the entire or substantially the entire bottom surfaces of the electrode stacks 14, 16 and thermal barrier 18, third insulative sheet 66 is sized to cover the entire or substantially the entire side surface of electrode stack 14 and fourth insulative sheet 68 is sized to cover the entire or substantially the entire side surface of electrode stack 16. First, second, third and fourth insulative sheets 62, 64, 66 and 68 have the same composition and make up as described above with respect to insulative sheet 60. Moreover, first, second, third and fourth insulative sheets 62, 64, 66 and 68 are configured to have thermal properties to inhibit heat transfer or heat conduction from the electrode stacks 14, 16. Cell assembly 130 is constructed by first placing or positioning the electrode stacks 14, 16 on either side of the thermal barrier 18, covering the entire or substantially the entire top surfaces of the electrode stacks 14, 16 and thermal barrier 18 with first insulative sheet 62, covering the entire or substantially the entire or substantially the entire bottom surfaces of the electrode stacks 14, 16 and thermal barrier 18 with the second insulative sheet 64, covering the entire or substantially the entire side surface of the electrode stack 14 with the third insulative sheet 66, covering the entire or substantially the entire side surface of the electrode stack 16 with the fourth insulative sheet 68 and then wrapping insulative tape 52 around the exterior of the electrode stacks 14, 16, the thermal barrier 18 and the first, second, third and fourth insulative sheets 62, 64, 66 and 68. Insulative tape 52 is configured as described above where like components or features are referenced using the like reference numerals. Insulative tape 52 with the adhesive coating functions to hold the cell assembly 130 together to form a single unit or assembly 130. While insulative tape 52 is shown in FIG. 5 as a single loop or wrap of tape around electrode stacks 14, 16, the thermal barrier 18 and first, second, third and fourth insulative sheets 62, 64, 66 and 68 the present disclosure contemplates multiple loops or wrappings of tape around electrode stacks 14, 16, the thermal barrier 18 and first, second, third and fourth insulative sheets 62, 64, 66 and 68.

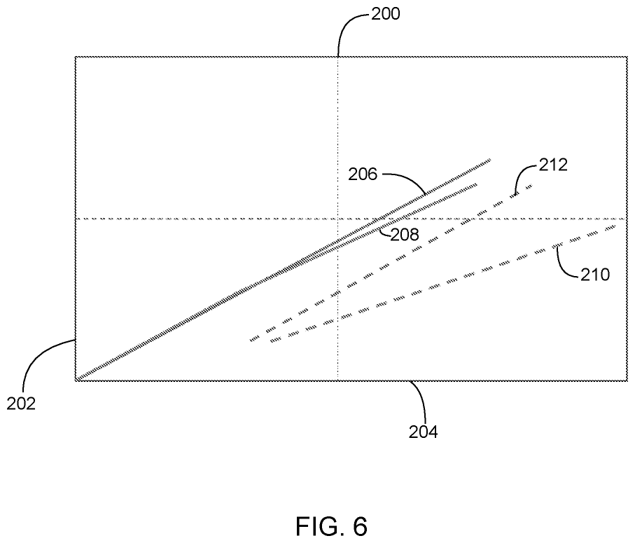

Referring now to FIG. 6, a chart 200 illustrating the effect on the temperature over time of an electrode stack 14 or 16 having the features of the present disclosure as constructed as described above and undergoing a rise in temperature as compared to an electrode stack that does not include a thermal barrier 18 or insulative sheets 60, or 62, 64, 66 and 68. The y-axis 202 of chart 200 is temperature and the x-axis 204 of chart 200 is time. Moreover, chart 200 includes a plot of temperature over time, depicted by line 206, of an electrode stack (not shown herein) that is adjacent a neighboring electrode stack (not shown) that do not have a thermal barrier 18 separating one another. Additionally, a plot of temperature over time is depicted by line 208 for an electrode stack 14 (as described above) that is positioned adjacent a neighboring electrode stack (electrode stack 16) that has a thermal barrier 18 separating the stacks to form, for example, one of the cell assemblies 28, 100, 110, 120, and 130 (as described above). As can be readily seen, the electrode stack that is assembled with another electrode stack and with a thermal barrier 18 therebetween undergoes a lower rise in temperature over time as compared to the electrode stack that is not adjacent or assembled with a thermal barrier 18. Moreover, a neighboring electrode stack, such as electrode stack 16 (as described above with respect to one of the cell assemblies 28, 100, 110, 120, and 130) also undergoes a lower rise in temperature over time as depicted by line 210 as compared to an electrode stack that is not assembled adjacent and with a thermal barrier 18 as depicted by line 212.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A prismatic battery comprising:
a first electrode stack having a first anode, a first cathode and a first separator disposed between the first anode and the first cathode;
a second electrode stack having a second anode, a second cathode and a second separator disposed between the second anode and the second cathode;
a thermal barrier disposed between the first and second electrode stack, wherein the first electrode stack, the thermal barrier and the second electrode stack form a first stack assembly; and
a housing containing an electrolyte, wherein the first stack assembly is disposed within an interior of the housing and submerged in the electrolyte.

2. The prismatic battery of claim 1 further comprising a thermally insulative tape wrapped around the first stack assembly wherein the insulative tape has a first and second surface wherein one of the first and second surfaces has an adhesive disposed thereon for adhering the thermally insulative tape to the first stack assembly.

3. The prismatic battery of claim 1 further comprising a first thermal insulative sheet disposed on a first side of the first stack assembly.

4. The prismatic battery of claim 3 further comprising a thermally insulative tape wrapped around the first thermal insulative sheet disposed on the first side of the first stack assembly wherein the insulative tape has a first and second surface wherein one of the first and second surfaces has an adhesive disposed thereon for adhering the insulative tape to the first stack assembly thereby securing the first thermal insulative sheet to the first stack assembly.

5. The prismatic battery of claim 3 further comprising a second thermal insulative sheet disposed on a second side of the first stack assembly.

6. The prismatic battery of claim 5 further comprising a thermally insulative tape wrapped around the first thermal insulative sheet disposed on the first side of the first stack assembly and the second thermal insulative sheet disposed on the second side of the first stack assembly wherein the insulative tape has a first and second surface wherein one of the first and second surfaces has an adhesive disposed thereon for adhering the insulative tape to the first stack assembly thereby securing the first and second thermal insulative sheet to the first stack assembly.

7. The prismatic battery of claim 5 further comprising a third thermal insulative sheet disposed on a third side of the first stack assembly.

8. The prismatic battery of claim 6 further comprising a thermally insulative tape wrapped around the first thermal insulative sheet disposed on the first side of the first stack assembly, the second thermal insulative sheet disposed on the second side of the first stack assembly and the third thermal insulative sheet disposed on the third side of the first stack assembly wherein the insulative tape has a first and second surface wherein one of the first and second surfaces has an adhesive disposed thereon for adhering the insulative tape to the first stack assembly thereby securing the first, second and third thermal insulative sheet to the first stack assembly.

9. The prismatic battery of claim 7 further comprising a fourth thermal insulative sheet disposed on a fourth side of the first stack assembly.

10. The prismatic battery of claim 9 further comprising a thermally insulative tape wrapped around the first thermal insulative sheet disposed on the first side of the first stack assembly, the second thermal insulative sheet disposed on the second side of the first stack assembly and the third thermal insulative sheet disposed on the third side of the first stack assembly and the fourth thermal insulative sheet disposed on the fourth side of the first stack assembly wherein the insulative tape has a first and second surface wherein one of the first and second surfaces has an adhesive disposed thereon for adhering the insulative tape to the first stack assembly thereby securing the first, second, third and fourth thermal insulative sheet to the first stack assembly.

11. The prismatic battery of claim 1 further comprising a first tab protruding from the first anode and a second tab protruding from the second anode wherein the first and second tab are made of copper and a third tab protruding from the first cathode and a fourth tab protruding from the second cathode wherein the third and fourth tab are made of aluminum.

12. A prismatic battery comprising:
a first electrode stack having a first anode, a first cathode and a first separator disposed between the first anode and the first cathode;
a second electrode stack having a second anode, a second cathode and a second separator disposed between the second anode and the second cathode;
a thermal barrier disposed between the first and second electrode stack, wherein the first electrode stack, the thermal barrier and the second electrode stack form a first stack assembly;
a first thermal insulative sheet disposed on a first side of the first stack assembly and
a housing containing an electrolyte, wherein the first stack assembly is disposed within an interior of the housing and submerged in the electrolyte.

13. The prismatic battery of claim 12 further comprising a thermally insulative tape wrapped around the first stack assembly and the first thermal insulative sheet wherein the insulative tape has a first and second surface wherein one of the first and second surfaces has an adhesive disposed thereon for adhering the insulative tape to the first stack assembly and securing the first thermal insulative sheet to the first stack assembly.

14. The prismatic battery of claim 12 further comprising a second thermal insulative sheet disposed on a second side of the first stack assembly.

15. The prismatic battery of claim 14 further comprising a thermally insulative tape wrapped around the first thermal insulative sheet disposed on the first side of the first stack assembly and the second thermal insulative sheet disposed on the second side of the first stack assembly wherein the insulative tape has a first and second surface wherein one of the first and second surfaces has an adhesive disposed thereon for adhering the insulative tape to the first stack assembly thereby securing the first and second thermal insulative sheet to the first stack assembly.

16. The prismatic battery of claim 14 further comprising a third thermal insulative sheet disposed on a third side of the first stack assembly.

17. The prismatic battery of claim 16 further comprising a thermally insulative tape wrapped around the first thermal insulative sheet disposed on the first side of the first stack assembly, the second thermal insulative sheet disposed on the second side of the first stack assembly and the third thermal insulative sheet disposed on the third side of the first stack assembly wherein the insulative tape has a first and second surface wherein one of the first and second surfaces has an adhesive disposed thereon for adhering the insulative tape to the first stack assembly thereby securing the first, second and third thermal insulative sheet to the first stack assembly.

18. The prismatic battery of claim 16 further comprising a fourth thermal insulative sheet disposed on a fourth side of the first stack assembly.

19. The prismatic battery of claim 18 further comprising a thermally insulative tape wrapped around the first thermal insulative sheet disposed on the first side of the first stack assembly, the second thermal insulative sheet disposed on the second side of the first stack assembly, the third thermal insulative sheet disposed on the third side of the first stack assembly and the fourth thermal insulative sheet disposed on the fourth side of the first stack assembly wherein the insulative tape has a first and second surface wherein one of the first and second surfaces has an adhesive disposed thereon for adhering the insulative tape to the first stack assembly thereby securing the first, second, third and fourth thermal insulative sheet to the first stack assembly.

20. A prismatic battery comprising:
a first electrode stack having a first anode, a first cathode and a first separator disposed between the first anode and the first cathode;
a second electrode stack having a second anode, a second cathode and a second separator disposed between the second anode and the second cathode;
a thermal barrier disposed between the first and second electrode stack, wherein the first electrode stack, the thermal barrier and the second electrode stack form a first stack assembly;
a first thermal insulative sheet disposed on a first side of the first stack assembly;
a second thermal insulative sheet disposed on a second side of the first stack assembly;
a third thermal insulative sheet disposed on a third side of the first stack assembly
a fourth thermal insulative sheet disposed on a fourth side of the first stack assembly;
a thermally insulative tape wrapped around the first thermal insulative sheet disposed on the first side of the first stack assembly, the second thermal insulative sheet disposed on the second side of the first stack assembly, the third thermal insulative sheet disposed on the third side of the first stack assembly and the fourth thermal insulative sheet disposed on the fourth side of the first stack assembly wherein the insulative tape has a first and second surface wherein one of the first and second surfaces has an adhesive disposed thereon for adhering the insulative tape to the first stack assembly thereby securing the first, second and third thermal insulative sheet to the first stack assembly; and
a housing containing an electrolyte, wherein the first stack assembly is disposed within an interior of the housing and submerged in the electrolyte.
